(19) United States
(12) Patent Application Publication
(10) Pub. No.: US 2003/0031520 A1
(43) Pub. Date: Feb. 13, 2003

(54) Cutting insert

(76) Inventors: Wofgang Hintze, Hamburg (DE); Andreas Wurfels, Koln (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/220,961

(22) PCT Filed: Feb. 20, 2001
(86) PCT No.: PCT/DE01/00674

(30) Foreign Application Priority Data
Apr. 13, 2000 (DE) 10018452.9

(51) Int. Cl. B23B 27/22; B23P 15/28

(52) U.S. Cl. 407/114; 407/116

(57) ABSTRACT

The invention relates to a cutting insert for machining work comprising at least one curved cutting corner configured from two cutting edges and comprising several regions with differing radii of curvature. On said cutting insert, at least one of the cutting edges is sunk across a partial section at a distance from the cutting corner centre, the latter being determined by the bisector of the cutting corner angle, but in the curved cutting corner region, or at least one of the cutting edges when viewed from above has a central convex cutting corner region, having a first radius of curvature (R₁) of an adjacent concave cutting corner region with a greater radius (R₃) and the concave cutting edge region is additionally raised in such a way that the cutting edge in this region runs in a convex manner when viewed from the side (looking onto the free surface).

The present invention relates to a cutting insert for chip-removing machining, in particular for facing and turning workpieces, the insert comprising a polygonal body with a chip face, a support face offset therefrom, free faces joining the chip and support faces and forming with the chip face respective cutting edges, and at least one curved cutting corner formed by two cutting edges and having a plurality of zones of different radii of curvature.

Such a cutting insert is for example known from EP 0,706,433. The cutting insert described there has seen in top view on the chip face a central cutting-corner zone with a first radius of curvature and flanking zones with a second larger radius of curvature. The cutting insert should be oriented so relative to the workpiece being machined that tangents of at least an intermediate point in the second zone with the larger radius of curvature extend parallel to the advance direction so that this cutting-edge region can produce a smooth workpiece surface during facing or turning.

WO 95/32071 and parallel U.S. Pat. No. 5,634,745 describe cutting inserts for turning whose rounded cutting corners are subdivided into at least five circle segments preferably arranged mirror symmetrically to a bisector of the cutting corner and that have at least three different radii satisfying the relationship that curved zones furthest from the cutting-corner center have a larger radius than the central cutting-corner zone and that this radius is larger than the radii of curvature in the intervening zones. In this document the acknowledged state of the art is the cutting corner(s) or the uniformly convexly shaped free-faze zones flanking the cutting corners.

U.S. Pat. No. 5,226,761 describes a cutting insert for turning or boring that has at least one cutting corner that in its central zone extending over an angle ε has a uniform radius of curvature and to each side over a length l straight cutting-edge zones that form an angle β greater than the angle ε. the cutting insert has on the chip face next to the cutting edge a chip-shaping groove so that the chip angle of the cutting corner is positive. The chip-shaping groove is formed by a descending angled flank adjacent the cutting edge that has a rising region leading toward the cutting-insert middle for breaking chips. The length l along which the cutting edge is straight should be at least as long as the maximal cutting-insert advance.

It is an object of the present invention to develop an alternative solution for a cutting insert that is intended during facing and turning, in particular for turning, to cut a workpiece surface with the same advance rate to produce less surface irregularities than a tool with a uniformly curved cutting corner.

This object is attained by the cutting insert according to claim 1.

According to the invention this cutting insert, which can be made as a one- or double-sided indexable cutting plate with two opposite chip faces, has not only a central cutting-corner zone with a first radius of curvature and flanking zones with a larger radius of curvature, but in addition a zone in which the cutting edge is recessed. This zone lies at a spacing from the cutting-corner center (intersection of a bisector of the cutting corner with the cutting edge) and produces in this region a concave cutting edge. With a negative mounting angle of such a cutting insert in a tool holder, the result is a flattening of the cutting edge over the described zone, which ensures very minor surface regularities even at high advance rates. Preferably the recessed cutting-edge zone reduces the cutting force. The spacing of the recessed cutting-edge zone from the cutting-corner center is determined mainly by the size of the cutting insert on the one hand and by the advance speed on the other, since the recessed cutting-edge zone serves as a cutter for smoothing or burnishing the workpiece surface.

Further embodiments of the invention are described in the dependent claims.

According to a concrete embodiment, the first radius of curvature is 0.1 mm to 2.4 mm, preferably 0.4 mm to 1.6 mm, and the second radius of curvature is 1 mm to 28 mm, preferably 4 mm to 19 mm. In addition or alternatively the larger radius of curvature is between six and ten times as great as the first radius of curvature according to the formula 6×R₁≦R₂≦12×R₁.

The spacing to a deepest point of the recessed cutting-edge zone relative to a level of the adjacent cutting edge outside the recess is between 0.04 mm and 0.4 mm, preferably between 0.1 mm and 0.2 mm. The zone of the cutting-edge recess is further (in the mathematical sense) uniformly concavely curved and lies generally in a region where the cutting edge has the larger radius of curvature preferably such that a portion of the recessed cutting-edge zone extends into the central cutting-corner zone with the radius of curvature. The cutting-edge recess is formed substantially mirror symmetrically to both sides of its deepest point, which lies in the region of greatest cutting-edge curvature.

As already mentioned the cutting insert is mounted in a cutting-insert holder in a negative position, preferably at a mounting angles equal to 3°≦α≦10° and 3°≦β≦10°, in particular at mounting angles between 5° and 8°. This mounting angle applies to cutting inserts whose free angles are 0°. With positive cutting inserts (cutting inserts with positive free angles) that are not seated negatively in a cutting-insert holder, the cutting-edge recess produces with appropriate mounting setups also a “flattening” of the cutting edge that serves as a smoothing cutter.

Alternatively the object is achieved by the cutting insert according to claim 7 which can be used as one- or two-sided indexable cutting plate.

In contrast to the above-described solution where the free face of the cutting-edge shape is shaped convexly and the chip face extends concavely in the recessed cutting=edge zone, in the alternative solution at least one of the cutting edges seen from above has a central convex cutting-corner zone with a first radius and an adjacent concave cutting-edge zone with a larger radius and the concave cutting-edge zone seen in edge view (toward the free face) is raised so that the cutting edge is convexly shaped in this zone. With this embodiment in the above-described cutting-edge zone the underlying free face is concave and the chip face adjacent the cutting edge is convex. The passive force increased by the described cutting-edge elevation can be compensate d for or reduced by a corresponding positive cutting angle.

According to a further development of this described embodiment the spacing from a highest point of the raised cutting-edge zone to adjacent unraised cutting-edges portions is between 0.04 mm and 0.4 mm, preferably between 0.1 mm and 0.2 mm.

According to a further variant on the described embodiment there is between the central cutting-edge zone and the concave cutting-edge zone a cutting-edge transition zone that has a radius of curvature between 0.1 mm and 0.4 mm.

Basically it is only necessary with the two described embodiments that one of the cutting edges have the corresponding raised or recessed zone. If the cutting insert is however to be employed both for right- and left-hand turning, the cutting edges are made mirror-symmetrical to the cutting-edge bisector, that is spaced to both sides of the cutting-corner center there is a raised or recessed zone of the cutting edge of the described shape.

In particular the described cutting-corner shape is formed in a rhombic cutting insert at opposite acute-angle cutting corners.

The length of the recessed or raised cutting-edge zones is according to an embodiment of the invention between 0.2 mm and 2.9 mm, preferably 0.4 mm and 1.2 mm, or alternatively satisfies the equation 0.4R₁≦bₛ≦1.2R₁ where R₁ is the ratio of the central cutting-corner zone and bₛ is the length of the recessed or raised cutting-edge zone.

Additionally and as known basically from the prior art, a chip-face zone adjacent and transverse to the cutting edge has a descending flank which according to a further embodiment is part of a chip-shaping groove that extends parallel to the cutting edge. In addition the cutting insert can have spaced from the cutting edge raised chip-shaping elements on the chip face that either extend into the chip-shaping groove or are spaced from it. The chip-shaping groove as well as any raised chip-shaping elements serve to bend the chip formed during machining and bend it such that it can break easily. Preferably an auxiliary edge of the cutting insert is set during machining of a workpiece, that is when mounted relative to the workpiece surface, at an angle equal to 2°≦κ≦10°, preferably 4°≦κ≦6°.

The present invention is described in the following with reference to further embodiments that are shown in the drawing. Therein:

FIG. 1 is a top view of a rhombic indexable cutting plate according to the invention;

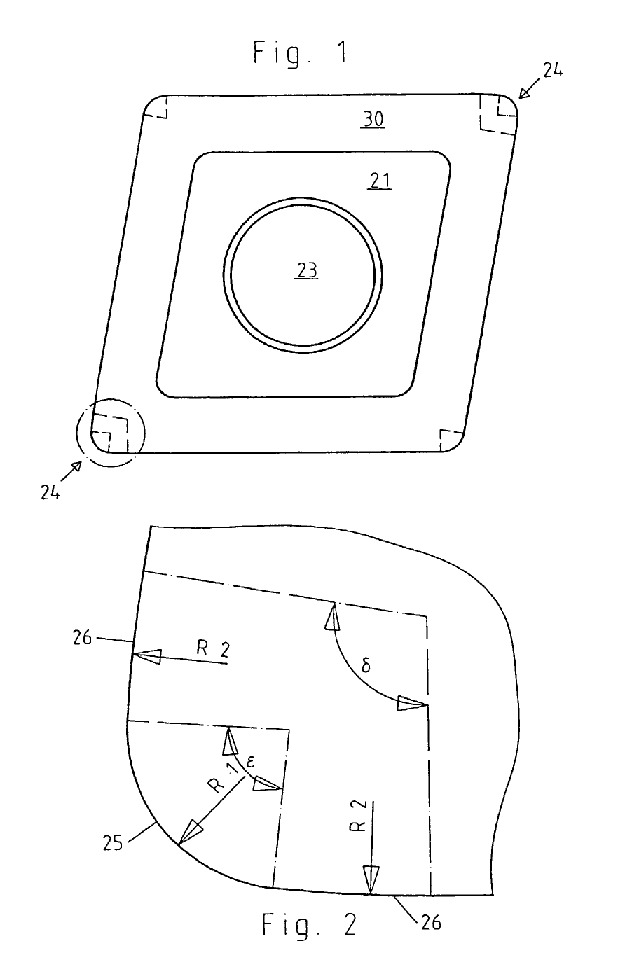

FIG. 2 is a detail view of a sharp-corner cutting corner of the cutting insert according to FIG. 1;

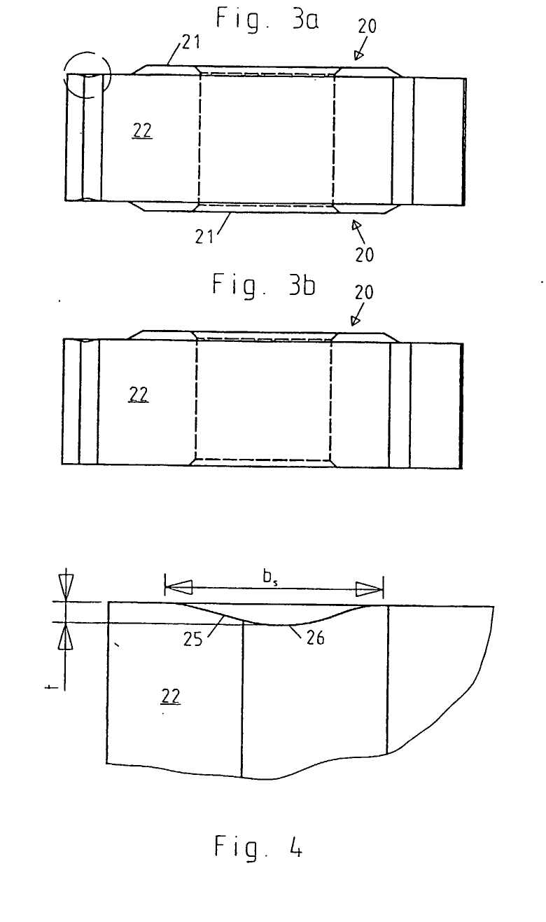

FIG. 3a is a side view of a double-sided indexable cutting insert according to FIG. 1;

FIG. 3b is a side view of a one-sided indexable cutting insert according to FIG. 1;

FIG. 4 is a detail view of a cutting edge in a corner region according to FIG. 3a;

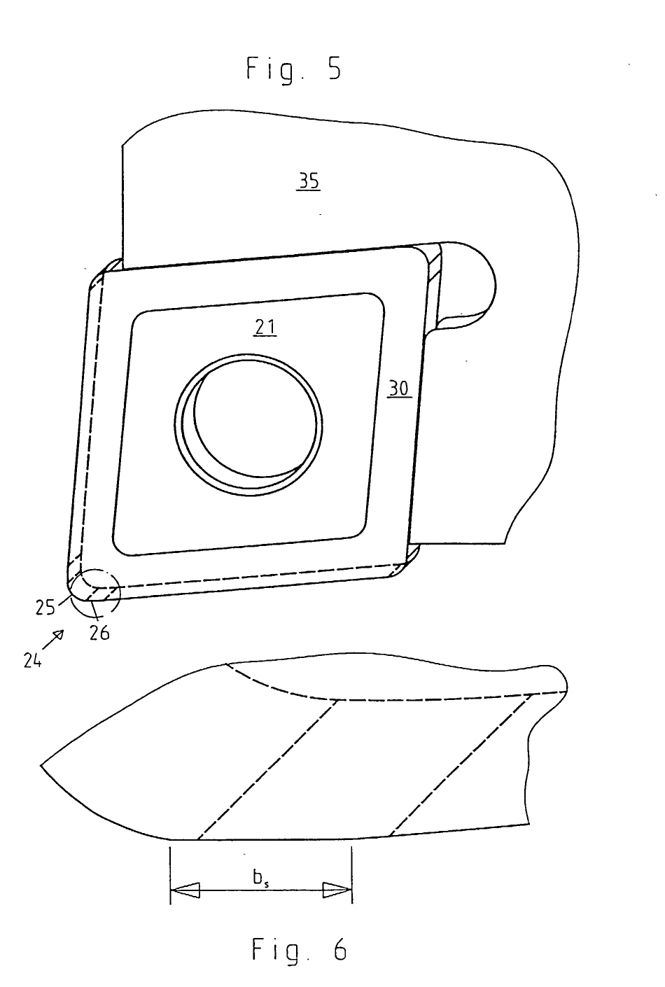

FIG. 5 shows the cutting insert according to FIGS. 1 to 4 in a schematic view installed in a cutting-insert holder;

FIG. 6 is a detail view of a cutting corner according to FIG. 5;

FIG. 7 is a top view of a rhombic cutting insert with free face at a positive angle;

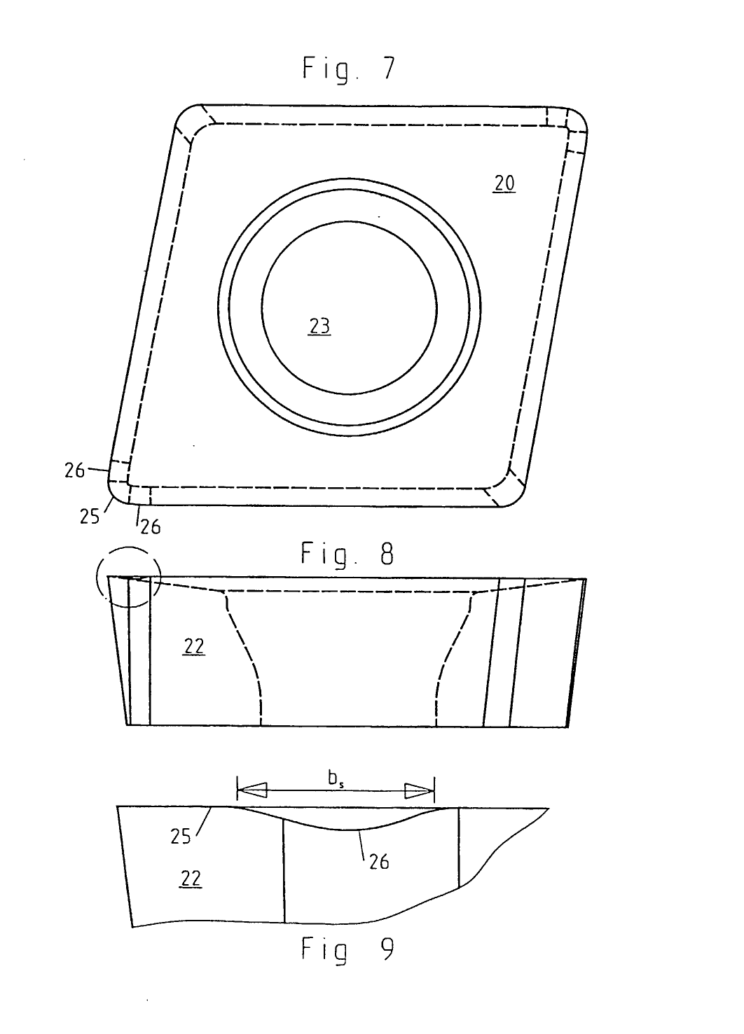

FIG. 8 is an edge view of the cutting insert according to FIG. 7;

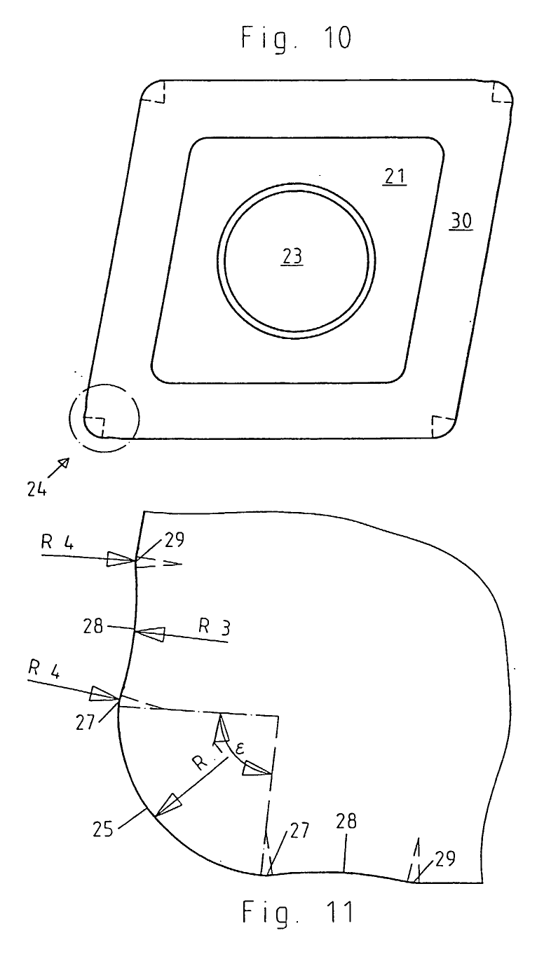

FIG. 9 is a detail of the cutting corner of the cutting insert according to FIG. 8;

FIG. 10 is a top view of a rhombic cutting insert in a further embodiment;

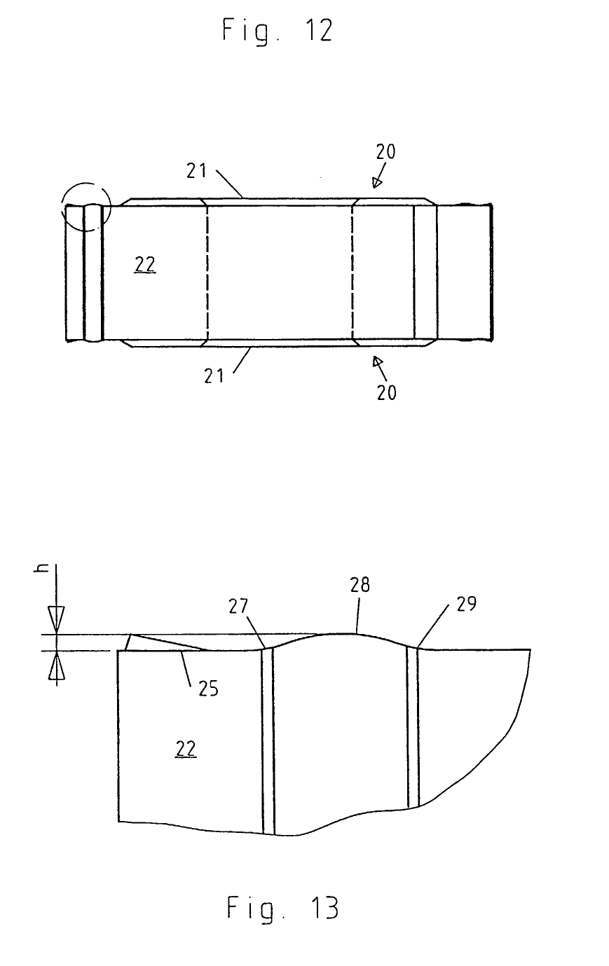

FIG. 11 is a detail view of the cutting corner of the cutting insert according to FIG. 10;

FIG. 12 is an edge view of the cutting insert according to FIG. 10;

FIG. 13 is a detail view of the cutting insert according to FIG. 12;

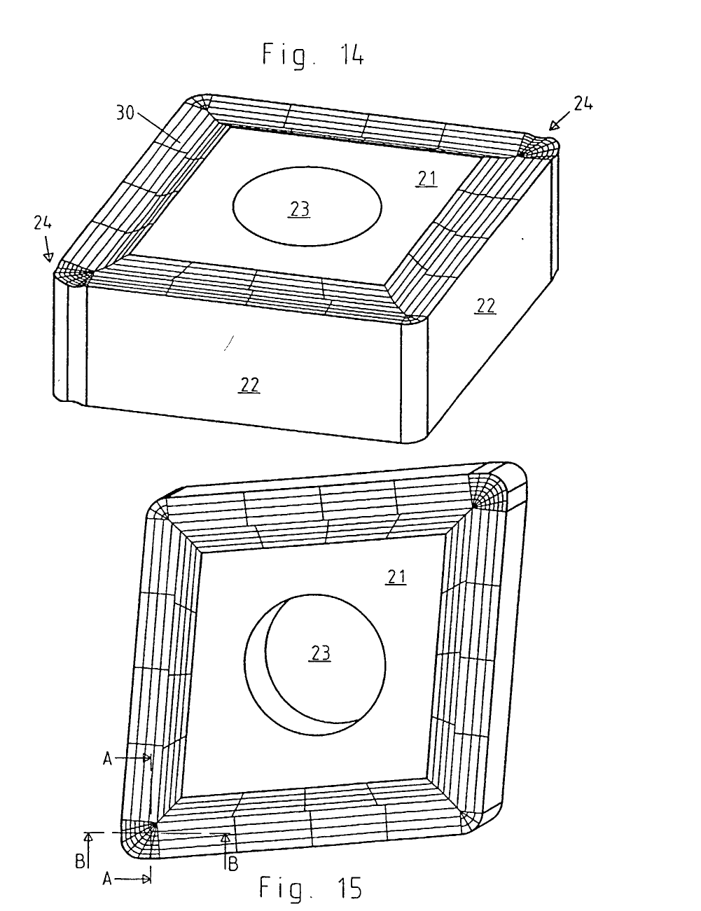

FIG. 14 is a perspective view of a indexable cutting insert with a chip-shaping groove;

FIG. 15 is the indexable cutting insert according to FIG. 14, positioned for use;

FIG. 16 is a section taken along line A--A of FIG. 15;

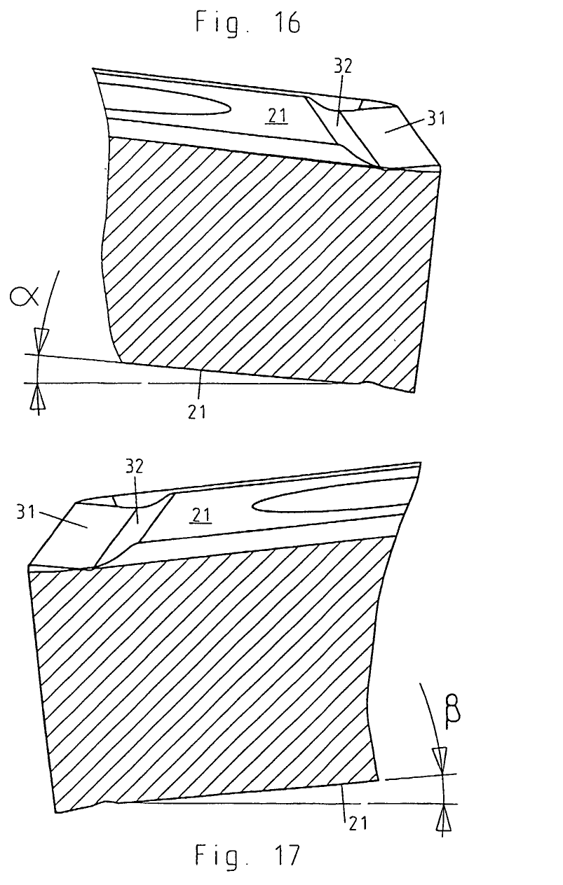

FIG. 17 is a section taken along line B--B of FIG. 15; and

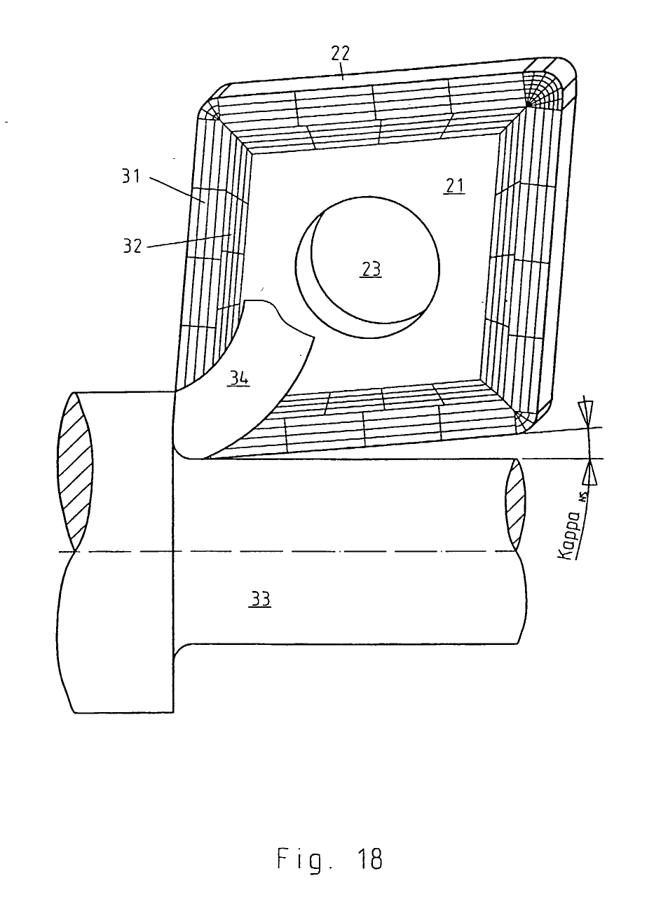

FIG. 18 shows an indexable cutting insert according to FIGS. 14 to 17 in position for longitudinal turning.

The cutting inserts shown in the drawing all have a chip face 20 and a support face 21 and respective free faces 22, the cutting inserts being designed as double-sided indexable cutting plates, that is the support face 21 can serve as a chip face and vice versa as shown in FIGS. 3a, 12, and 14 to 18. In order to mount the cutting plate on a holder, a mounting hole 23 for receiving a mounting bolt is provided. As visible from FIGS. 1 to 9, the cutting plate is shaped in the region of the acute-angle corners 24 according to the invention such that a central zone 25 of the cutting corner, which in this case extends over an angle ε≦90°, is smoothly convexly rounded. This zone 25 has a radius of curvature R₁ of the above-described size. In the respective flanking second zones 26, from which lines drawn from the ends form an angle δ≦90°, in this case 100°. The cutting-edge zones 26 are also convexly curved and have a radius R₂which is larger than the described radius R₁. As particularly visible in FIG. 4, the cutting edge is recessed in a zone of a length bₛ (see FIG. 6) which is generally in the region where the cutting edge has the radius R₂. The recess extends in one direction into the central cutting-corner zone with the radius R₁. This cutting-edge recessing with a maximum depth, which corresponds to a spacing t of the cutting-edge minimum from the level of the cutting edge adjacent the recess, imparts a concave shape in this region to the chip face.

FIG. 5 shows the cutting insert according to FIGS. 1 to 4 when mounted in a holder 35. As a result of the selected negative mounting angle the cutting-edge recess is effective over the region bₛ as a flattening of the cutting edge that during machining cuts a surface with little irregularities.

FIGS. 7 to 9 show another cutting insert which is only different from the cutting insert described above in that it has free faces 22 set at a positive free angle. The similar cutting-edge recess thus gives the same results when the cutting insert is held at a 0° or positive mounting angle in a holder.

Alternatively to the above-described cutting inserts, the cutting insert according to FIGS. 10 to 13 are shaped in the cutting-corner region such that the central cutting-corner zone with the radius R₁ is flanked by two transition zones 27 with a convex radius R₄ and there adjacent by concave cutting-edge zones 28 that merge via small transition zones 29 with the above-cited radius R₄ as extensions of the cutting edge. In the concave zones 28 of the cutting edge, below which the free face is also concave, the cutting edge in a side view like FIG. 13 also is raised by the spacing h shown in FIG. 13 so that there is a concave cutting-edge shape seen in a side view along the free face.

FIGS. 14 to 17 furthermore show that a chip-shaping groove 30 is formed over the entire length of the cutting edge, in particular however in the region of the cutting corners and is as shown in FIG. 16 comprised of a descending flank 31 forming a positive chip angle as well as an ascending flank 32. The angles a and β show the mounting position of the cutting insert in its holder, which is determined by the inclination of the support face used.

FIG. 18 shows a cutting insert mounted for the longitudinal turning of a workpiece 33 at a mounting angle κ (of the auxiliary cutter) which lies between 2° and 10°, preferably 420 to 6°. The outgoing chip 34 is shown schematically.

1. A cutting insert for chip-removing machining, in particular for facing and turning workpieces (33), the insert comprising a polygonal body with a chip face (20), a support face (21) offset therefrom, and free faces (22) joining the chip and support faces, the free faces (22) forming with the chip face (20) respective cutting edges, two of the cutting edges forming at least one rounded cutting corner (24) that, seen in top view looking at the chip face (29), has a central zone (25) with a first radius of curvature (R₁) and flanking second zones (26) with a second larger radius of curvature (R₂), characterized in that at least one of the cutting edges is recessed in the flanking second zones (26) in a zone (bₛ) offset from a cutting-corner center point lying on a cutting-corner bisector.

2. The cutting insert according to claim 1, characterized in that the first radius of curvature (R₁) is 0.1 mm to 2.4 mm, preferably 0.4 mm to 1.6 mm, and the second radius of curvature (R₂) is 1 mm to 28 mm, preferably 4 mm to 19 mm, and/or that the larger radius of curvature (R₂) is between six and ten times as great as the first radius of curvature (6×R₁≦R₂≦12×R₁).

3. The cutting insert according to claim 1 or 2, characterized in that the spacing (t) to a deepest point of the recessed cutting-edge zone relative to a level of the adjacent cutting edge outside the recess is between 0.04 mm and 0.4 mm, preferably between 0.1 mm and 0.2 mm.

4. The cutting insert according to one of claims 1 to 3, characterized in that the region of the cutting-edge recess is uniformly concavely curved and lies generally in a region where the cutting edge has the larger radius of curvature (R₂) preferably such that a portion of the recessed cutting-edge zone extends into the central cutting-corner zone with the radius of curvature (R₁).

5. The cutting insert according to one of claims 1 to 4, characterized in that the cutting insert is mounted in a cutting-insert holder in a negative position at a mounting angles (α) and (β) equal to 3°≦α≦10° and 3°≦β≦10°, preferably 5°≦α≦8° and 5°≦β≦8°.

6. The cutting insert according to one of claims 1 to 4, characterized in that the cutting insert has free faces set at a positive angle and is mounted in the cutting-insert holder at 0° or a positive mounting angle.

7. A cutting insert for chip-removing machining, in particular for facing and turning workpieces (33), the insert comprising a polygonal body with a chip face (20), a support face (21) offset therefrom, free faces (22) joining the chip and support faces (22) and forming with the chip face (20) respective cutting edges, and at least one curved cutting corner formed by two cutting edges and having a plurality of zones of different radii of curvature, characterized in that at least one of the cutting edges seen from above has a central convex cutting-corner zone with a first radius (R₁) and an adjacent concave cutting-edge zone with a larger radius (R₃) and that the concave cutting-edge zone seen in edge view (toward the free face) is raised so that the cutting edge is convexly shaped in this zone.

8. The cutting insert according to claim 7, characterized in that the spacing (h) from a highest point of the raised cutting-edge zone to adjacent unraised cutting-edges portions is between 0.04 mm and 0.4 mm, preferably between 0.1 mm and 0.2 mm.

9. The cutting insert according to claim 7 or 8, characterized in that between the central cutting-edge zone and the concave cutting-edge zone is a cutting-edge transition zone that has a radius of curvature (R₄) between 0.1 mm and 0.4 mm.

10. The cutting insert according to one of claim 1 to 9, characterized in that the cutting edges are mirror-symmetrical to a bisector of the cutting-edge corner.

11. The cutting insert according to one of claim 1 to 10, characterized in that the cutting insert is rhombic and the differently curved cutting-edge zones are formed in opposite acute-angle cutting corners.

12. The cutting insert according to one of claims 1 to 11, characterized in that the recessed or raised cutting-edge zone has a length (bₛ) between 0.2 mm and 2.9 mm, preferably 0.4 mm and 1.2 mm, and/or satisfies the equation 0.4R₁≦bₛ≦1.2R₁.

13. The cutting insert according to one of claims 1 to 12, characterized in that a chip-face zone adjacent and transverse to the cutting edge has a descending flank.

14. The cutting insert according to claim 13, characterized in that the flank (31) is part of a chip-shaping groove (30) that extends parallel to the cutting edge.

15. The cutting insert according to one of claim 1 to 14, characterized in that raised chip-shaping elements are provided on the chip face at a spacing from the cutting edge.

16. The cutting insert according to one of claim 1 to 15, characterized in that an auxiliary edge of the cutting insert is set during machining of a workpiece at an angle κ equal to 2°≦κ≦10°, preferably 4°≦κ≦6°.
